(19) United States
(12) Patent Application Publication
(10) Pub. No.: US 2023/0395319 A1
(43) Pub. Date: Dec. 7, 2023

(54) WOUND CORE, METHOD OF PRODUCING WOUND CORE AND WOUND CORE PRODUCTION DEVICE

(71) Applicant: NIPPON STEEL CORPORATION, Tokyo (JP)

(72) Inventors: Takahito MIZUMURA, Tokyo (JP); Hisashi MOGI, Tokyo (JP); Masato MIZOKAMI, Tokyo (JP); Masaru TAKAHASHI, Tokyo (JP)

(73) Assignee: NIPPON STEEL CORPORATION, Tokyo (JP)

(21) Appl. No.: 18/033,120

(22) PCT Filed: Oct. 26, 2021
(86) PCT No.: PCT/JP2021/039530

§ 371 Date: Apr. 21, 2023

(30) Foreign Application Priority Data
Oct. 26, 2020 (JP) 2020-178565

(51) Int. Cl. H01F 41/02; H01F 27/245; H01F 3/04

(52) U.S. Cl. CPC H01F 41/024; H01F 27/2455; H01F 3/04

(57) ABSTRACT

A wound core (10) in which, in a laminating direction, when the surface roughness of a steel sheet portion in a direction connecting a center in a sheet thickness direction of a grain-oriented electrical steel sheet (1) positioned on the innermost periphery of the wound core among the laminated grain-oriented electrical steel sheets (1) and a center in the sheet thickness direction of the grain-oriented electrical steel sheet (1) positioned on the outermost periphery of the wound core (10) is Ral, and the surface roughness of the grain-oriented electrical steel sheet (1) in a direction parallel to a longitudinal direction on an end surface of a planar portion (4) of the laminated grain-oriented electrical steel sheet (1) is Rac, a ratio Ral/Rac between Rat and Rac satisfies the relationship of 1.5≤Ral/Rac≤12.0.

### TECHNICAL FIELD

The present invention relates to a wound core, a method of producing a wound core, and a wound core production device. Priority is claimed on Japanese Patent Application No. 2020-178565, filed Oct. 26, 2020, the content of which is incorporated herein by reference.

### BACKGROUND ART

Transformer iron cores include stacked iron cores and wound cores. Among these, the wound core is generally produced by stacking grain-oriented electrical steel sheets in layers, winding them in a donut shape (wound shape), and then pressing the wound body to mold it into substantially a rectangular shape (in this specification, a wound core produced in this manner may be referred to as a trunk core). According to this molding process, mechanical processing strain (plastic deformation strain) is applied to all of the grain-oriented electrical steel sheets, and the processing strain is a factor that greatly deteriorates the iron loss of the grain-oriented electrical steel sheet so that it is necessary to perform strain relief annealing.

On the other hand, as another method of producing a wound core, techniques such as those found in Patent Documents 1 to 3 in which portions of steel sheets that become corner portions of a wound core are bent in advance so that a relatively small bending area with a radius of curvature of 3 mm or less is formed and the bent steel sheets are laminated to form a wound core are disclosed (in this specification, the wound core produced in this manner may be referred to as Unicore (registered trademark)). According to this production method, a conventional large-scale molding process is not required, the steel sheet is precisely bent to maintain the shape of the iron core, and processing strain is concentrated only in the bent portion (corner) so that it is possible to omit strain removal according to the above annealing process, and its industrial advantages are great and its application is progressing.

### CITATION LIST

### Patent Document

### [Patent Document 1]

Japanese Unexamined Patent Application, First Publication No. 2005-286169

### [Patent Document 2]

Japanese Patent No. 6224468

### [Patent Document 3]

Japanese Unexamined Patent Application, First Publication No. 2018-148036

### SUMMARY OF THE INVENTION

### Problems to be Solved by the Invention

Incidentally, in the unannealed Unicore, base steel is exposed to a slit part on an end surface of laminated steel sheets, and due to strain at the slit part, heat is generated at the end surface when the core is used to produce a transformer. This heat generation makes it difficult to control the temperature of the iron core and the winding wire, and therefore, until now, the iron core and the winding wire have been immersed in an oil or even if they are not immersed in an oil according to provision of a cooling duct, attempts have been made to minimize the temperature rise by circulating air. However, due to a large temperature rise of the iron core and the winding wire, it is still difficult to control the temperature rise.

The present invention has been made in view of the above circumstances, and an object of the present invention is to provide a wound core, a method of producing a wound core, and a wound core production device through which it is possible to reduce a temperature rise of an iron core and a winding wire.

### Means for Solving the Problem

In order to achieve the above object, the present invention provides a wound core having a wound shape including a rectangular hollow portion in the center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll, in an L cross section parallel to the longitudinal direction which is a cross section of the grain-oriented electrical steel sheet in a thickness direction, when the surface roughness of a steel sheet portion along a straight line connecting an arbitrary point on a grain-oriented electrical steel sheet positioned on the innermost periphery of the wound shape among the laminated grain-oriented electrical steel sheets and an arbitrary point on a grain-oriented electrical steel sheet positioned on the outermost periphery is Ral, and the surface roughness of a steel sheet portion along a straight line connecting arbitrary points on an end surface in a sheet thickness direction parallel to the longitudinal direction in any one of the laminated grain-oriented electrical steel sheets is Rae, the ratio Ral/Rac satisfies the relationship of 1.5≤Ral/Rac≤12.0. Here, “L cross section parallel to the longitudinal direction which is a cross section of the grain-oriented electrical steel sheet in a thickness direction” is not a surface after the wound core is cut out but an end surface of the wound core parallel to the longitudinal direction of the grain-oriented electrical steel sheets in the thickness direction of the grain-oriented electrical steel sheet. The surface roughness Ral may be a surface roughness of a steel sheet portion in a direction connecting a center in the sheet thickness direction of the grain-oriented electrical steel sheet positioned on the innermost periphery of the wound core among the laminated grain-oriented electrical steel sheets in the sheet thickness direction of the grain-oriented electrical steel sheet and a center in the sheet thickness direction of the grain-oriented electrical steel sheet positioned on the outermost periphery. The surface roughness Rae may be the surface roughness of the grain-oriented electrical steel sheet in a direction parallel to the longitudinal direction on an end surface of the planar portion of the laminated grain-oriented electrical steel sheet.

The inventors have taken into account the fact that it is difficult to control the temperature of the iron core and the winding wire even though heat generated on the end surface when a Unicore is used to produce a transformer is immersed in an oil, focused on the fact that, if the surface area of the L cross section of the wound core can be increased with substantially the same wound core volume, a contact area with an oil or air can increase, and thereby the cooling efficiency can increase, and found that, when any one or more of the grain-oriented electrical steel sheets that are stacked such that each of the grain-oriented electrical steel sheets forms one corresponding layer are assembled over the entire length in the longitudinal direction so that they are shifted with respect to grain-oriented electrical steel sheets forming other layers in a width direction perpendicular to the longitudinal direction, the surface roughness Ral of the L cross section of the wound core (the surface roughness of a steel sheet portion along a straight line connecting an arbitrary point on a grain-oriented electrical steel sheet positioned on the innermost periphery and an arbitrary point on a grain-oriented electrical steel sheet positioned on the outermost periphery) is changed, and thus the ratio Ral/Rac of the surface roughness satisfies the relationship of 1.5≤Ral/Rac≤12.0, it is possible to effectively increase the surface area of the L cross section of the wound core, and when a wound core (Unicore) is used as a transformer, it is possible to increase a contact area with an oil or air, and it is possible to greatly improve the cooling efficiency. In addition, they found that, when the ratio Ral/Rac of the surface roughness exceeds 12.0, the magnetic flux flow becomes unstable, and the iron loss deteriorates. Here, the L cross section of the wound core is not a cut surface of the wound core but an end surface of the wound core parallel to the longitudinal direction of the grain-oriented electrical steel sheets in the sheet thickness direction of the grain-oriented electrical steel sheet. Here, the surface roughness Ral may be, for example, in the sheet thickness direction of the grain-oriented electrical steel sheet, the surface roughness of a steel sheet portion in a direction connecting a center in the sheet thickness direction of the grain-oriented electrical steel sheet positioned on the innermost periphery and a center in the sheet thickness direction of the grain-oriented electrical steel sheet positioned on the outermost periphery.

Based on such findings, in the above configuration in the present invention, since the surface roughness ratio Ral/Rac satisfies the relationship of 1.5≤Ral/Rac≤12.0, it is possible to effectively reduce the temperature rise of the iron core and the winding wire.

Here, in the above configuration, the direction of the straight line connecting an arbitrary point on a grain-oriented electrical steel sheet positioned on the innermost periphery and an arbitrary point on a grain-oriented electrical steel sheet positioned on the outermost periphery can be arbitrarily set. Particularly, in the sheet thickness direction of the grain-oriented electrical steel sheet, a direction connecting a center in the sheet thickness direction of the grain-oriented electrical steel sheet positioned on the innermost periphery of the wound core among the laminated grain-oriented electrical steel sheets and a center in the sheet thickness direction of the grain-oriented electrical steel sheet positioned on the outermost periphery is preferable. In addition, as long as the relationship of 1.5≤Ral/Rac≤12.0 can be satisfied, the number of grain-oriented electrical steel sheets to be shifted in the width direction is arbitrary, and as an aspect of shifting the grain-oriented electrical steel sheets in the width direction, for example, it is conceivable to shift the grain-oriented electrical steel sheets in the laminating direction irregularly or regularly. In the case of regular shifting, various aspects are conceivable such as an aspect in which the grain-oriented electrical steel sheets are alternately shifted between adjacent layers and an aspect of shifting in units of multiple layers, for example, every two layers are shifted or every three layers are shifted. In addition, as a method of shifting the grain-oriented electrical steel sheets in the width direction, as an example, a method in which a guide that regulates positions of both ends of the grain-oriented electrical steel sheets in the width direction and guides the grain-oriented electrical steel sheets in the longitudinal direction is provided and the grain-oriented electrical steel sheets are shifted in the width direction by changing the position of the guide is conceivable, but the present invention is not limited thereto. In addition, for example, the surface roughness can be calculated based on the arithmetic average roughness Ra defined in Japanese Industrial Standard JIS B 0601 (2013).

In addition, the present invention provides a method of producing a wound core that is a wound core having a wound shape including a rectangular hollow portion in the center and a portion in which grain-oriented electrical steel sheets in which planar portions and bent portions are alternately continuous in a longitudinal direction are stacked in a sheet thickness direction which is a wound core formed by stacking the grain-oriented electrical steel sheets that have been individually bent in layers and assembled into a wound shape and in which the plurality of grain-oriented electrical steel sheets are connected to each other via at least one joining part for each roll, in which any one or more of the grain-oriented electrical steel sheets that are stacked such that each of the grain-oriented electrical steel sheets forms one corresponding layer are assembled over the entire length in the longitudinal direction L so that they are shifted with respect to the grain-oriented electrical steel sheets forming other layers in the width direction perpendicular to the longitudinal direction, and thereby, in an L cross section parallel to the longitudinal direction which is a cross section of the grain-oriented electrical steel sheets in a thickness direction, when the surface roughness of a steel sheet portion along a straight line connecting an arbitrary point on a grain-oriented electrical steel sheet positioned on the innermost periphery of the wound shape among the laminated grain-oriented electrical steel sheets and an arbitrary point on a grain-oriented electrical steel sheet positioned on the outermost periphery is Ral, and the surface roughness of a steel sheet portion along a straight line connecting arbitrary points on an end surface in a sheet thickness direction parallel to the longitudinal direction of any one of the laminated grain-oriented electrical steel sheets is Rac, the ratio Ral/Rac satisfies the relationship of 1.5≤Ral/Rac≤12.0.

The production method may be a production method in which, in an end surface of the wound core that is in a sheet thickness direction of the grain-oriented electrical steel sheets and parallel to the longitudinal direction of the grain-oriented electrical steel sheets, in the sheet thickness direction of the grain-oriented electrical steel sheets, when the surface roughness of a steel sheet portion in a direction connecting a center in the sheet thickness direction of a grain-oriented electrical steel sheet positioned on the innermost periphery of the wound core and a center in the sheet thickness of a grain-oriented electrical steel sheet positioned on the outermost periphery of the wound core is Ral. and the surface roughness of the grain-oriented electrical steel sheet in a direction parallel to the longitudinal direction on an end surface of the planar portion of the laminated grain-oriented electrical steel sheet is Rae, the method including stacking the grain-oriented electrical steel sheets so that a ratio Ral/Rac between Ral and Rac satisfies the relationship of 1.5≤Ral/Rac≤12.0 and each of the grain-oriented electrical steel sheets forms one layer of the wound core of the present disclosure and assembling any one or more of the stacked grain-oriented electrical steel sheets over the entire length in the longitudinal direction so that they are shifted with respect to grain-oriented electrical steel sheets forming other layers in a width direction perpendicular to the longitudinal direction of the grain-oriented electrical steel sheet.

In addition, the present invention also provides a wound core production device including a bending unit that individually bends grain-oriented electrical steel sheets and an assembly unit that stacks the grain-oriented electrical steel sheets that have been individually bent in layers by the bending unit and assembles them into a wound shape to form a wound core having a wound shape including a rectangular hollow portion in the center in which the plurality of grain-oriented electrical steel sheets are connected to each other via at least one joining part for each roll and which includes a portion in which grain-oriented electrical steel sheets in which planar portions and bent portions are alternately continuous in a longitudinal direction are stacked in a sheet thickness direction, in which the assembly unit assembles any one or more of the grain-oriented electrical steel sheets that are stacked such that each of the grain-oriented electrical steel sheets forms one corresponding layer over the entire length in the longitudinal direction so that they are shifted with respect to grain-oriented electrical steel sheets forming other layers in a width direction perpendicular to the longitudinal direction, and thereby, in an L cross section parallel to the longitudinal direction which is a cross section of the grain-oriented electrical steel sheet in a thickness direction, when the surface roughness of a steel sheet portion along a straight line connecting an arbitrary point on a grain-oriented electrical steel sheet positioned on the innermost periphery of the wound shape among the laminated grain-oriented electrical steel sheets and an arbitrary point on a grain-oriented electrical steel sheet positioned on the outermost periphery is Ral, and the surface roughness of a steel sheet portion along a straight line connecting arbitrary points on an end surface in a sheet thickness direction parallel to the longitudinal direction in any one of the laminated grain-oriented electrical steel sheets is Rac, the ratio Ral/Rac satisfies the relationship of 1.5≤Ral/Rac≤12.0, and the assembly unit includes a guide that regulates positions of both ends of the grain-oriented electrical steel sheet in the width direction and guides the grain-oriented electrical steel sheet in the longitudinal direction, and the grain-oriented electrical steel sheet is shifted in the width direction by changing the position of the guide.

The wound core production device includes a bending unit that individually bends grain-oriented electrical steel sheets and an assembly unit that stacks the grain-oriented electrical steel sheets that have been individually bent in layers by the bending unit and assembles them into a wound shape to form a wound core having a wound shape including a rectangular hollow portion in the center in which the plurality of grain-oriented electrical steel sheets are connected to each other via at least one joining part for each roll and which includes a portion in which grain-oriented electrical steel sheets in which planar portions and bent portions are alternately continuous in a longitudinal direction are stacked in a sheet thickness direction, in which the assembly unit includes a guide that regulates positions of both ends of the grain-oriented electrical steel sheet in the width direction and guides the grain-oriented electrical steel sheet in the longitudinal direction, and the assembly unit stacks the grain-oriented electrical steel sheets so that each sheet forms one layer of the wound core, and assembles any one or more of the stacked grain-oriented electrical steel sheets over the entire length in the longitudinal direction so that they are shifted with respect to the grain-oriented electrical steel sheets forming other layers in the width direction perpendicular to the longitudinal direction by changing the position of the guide so that in an end surface of the wound core that is in a sheet thickness direction of the grain-oriented electrical steel sheets and parallel to the longitudinal direction of the grain-oriented electrical steel sheets, in the sheet thickness direction, when the surface roughness of a steel sheet portion in a direction connecting a center in the sheet thickness direction of a grain-oriented electrical steel sheet positioned on the innermost periphery of the wound core among the laminated grain-oriented electrical steel sheets and a center in the sheet thickness direction of a grain-oriented electrical steel sheet positioned on the outermost periphery of the wound core is Ral, and the surface roughness of the grain-oriented electrical steel sheet in a direction parallel to the longitudinal direction on an end surface of the planar portion of the laminated grain-oriented electrical steel sheet is Rac, a ratio Ral/Rac between Ral and Rac satisfies the relationship of 1.5≤Ral/Rac≤12.0.

According to such a method of producing a wound core and production device, as in the above wound core, since the surface roughness ratio Ral/Rac satisfies the relationship of 1.5≤Ral/Rac≤12.0, it is possible to effectively reduce the temperature rise of the iron core and the winding wire.

### Effects of the Invention

According to the present invention, since the surface roughness ratio Ral/Rac satisfies the relationship of 1.5≤Ral/Rac≤12.0, it is possible to effectively reduce the temperature rise of the iron core and the winding wire.

### BRIEF DESCRIPTION OF DRAWINGS

FIG. 1 is a perspective view schematically showing a wound core according to one embodiment of the present invention.

FIG. 2 is a side view of the wound core shown in the embodiment of FIG. 1.

FIG. 3 is a side view schematically showing a wound core according to another embodiment of the present invention.

FIG. 4 is a side view schematically showing an example of a single-layer grain-oriented electrical steel sheet constituting a wound core.

FIG. 5 is a side view schematically showing another example of the single-layer grain-oriented electrical steel sheet constituting the wound core.

FIG. 6 is a side view schematically showing an example of a bent portion of the grain-oriented electrical steel sheet constituting the wound core of the present invention.

FIG. 7(a) is a vertical end view showing an example of setting a straight line that defines a surface roughness Ral of an end surface of a laminated structure of a wound core formed by laminating grain-oriented electrical steel sheets, and FIG. 7(b) is a side end view showing an example of setting a straight line that defines a surface roughness Rac on an end surface that is parallel to a longitudinal direction of any one grain-oriented electrical steel sheet and in a sheet thickness direction.

FIG. 8 is a horizontal cross-sectional view that is parallel to a width direction of a wound core laminated structure formed by laminating grain-oriented electrical steel sheets and in a sheet thickness direction (an end view of a cut portion along the line A-A in FIG. 1).

FIG. 9 is a block diagram schematically showing a configuration of a wound core production device forming a Unicore type.

FIG. 10 is a schematic perspective view of a wound core around which a winding wire is wound, which is the content of a transformer.

FIG. 11 is a perspective view of the production device of FIG. 9 schematically showing an assembly unit including a guide for shifting grain-oriented electrical steel sheets supplied from a bending unit in a width direction.

FIG. 12 is a schematic view showing sizes of a wound core produced when properties are evaluated.

### EMBODIMENT(S) FOR IMPLEMENTING THE INVENTION

Hereinafter, a wound core according to one embodiment of the present invention will be described in detail in order. However, the present invention is not limited to only the configuration disclosed in the present embodiment, and can be variously modified without departing from the gist of the present invention. Here, lower limit values and upper limit values are included in the numerical value limiting ranges described below. Numerical values indicated by “more than” or “less than” are not included in these numerical value ranges. In addition, unless otherwise specified, “%” relating to the chemical composition means “mass %.”

In addition, terms such as “parallel,” “perpendicular,” “identical,” and “right angle” and length and angle values used in this specification to specify shapes, geometric conditions and their extents are not bound by strict meanings, and should be interpreted to include the extent to which similar functions can be expected.

In addition, in this specification, “grain-oriented electrical steel sheet” may be simply described as “steel sheet” or “electrical steel sheet,” and “wound core” may be simply described as “iron core.”

The wound core according to one embodiment of the present invention is a wound core including a substantially rectangular wound core main body in a side view, and the wound core main body includes a portion in which grain-oriented electrical steel sheets in which planar portions and bent portions are alternately continuous in the longitudinal direction are stacked in a sheet thickness direction and has a substantially polygonal laminated structure in a side view. Here, the planar portion is a straight portion other than the bent portion. As an example, the grain-oriented electrical steel sheet has a chemical composition containing, in mass %, Si: 2.0 to 7.0%, with the remainder being Fe and impurities, and has a texture oriented in the Goss orientation. As the grain-oriented electrical steel sheet, for example, a grain-oriented electromagnetic steel band described in JIS C 2553: 2019 can be used.

Next, the shapes of the wound core and the grain-oriented electrical steel sheet according to one embodiment of the present invention will be described in detail. The shapes themselves of the wound core and the grain-oriented electrical steel sheet described here are not particularly new, and merely correspond to the shapes of known wound cores and grain-oriented electrical steel sheets.

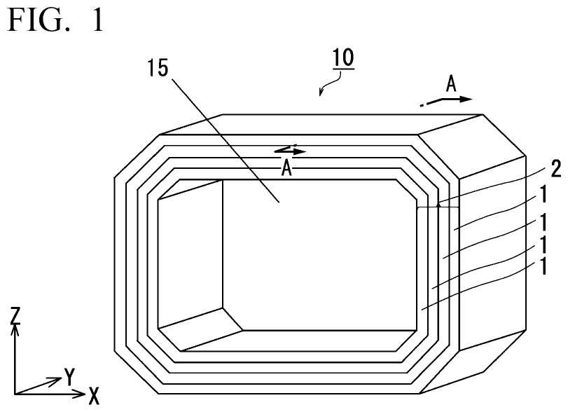

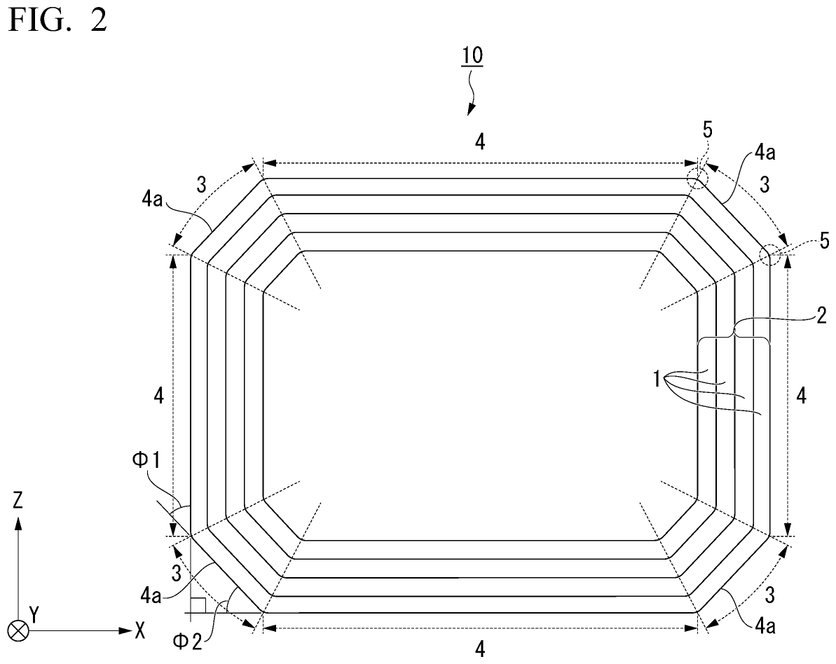

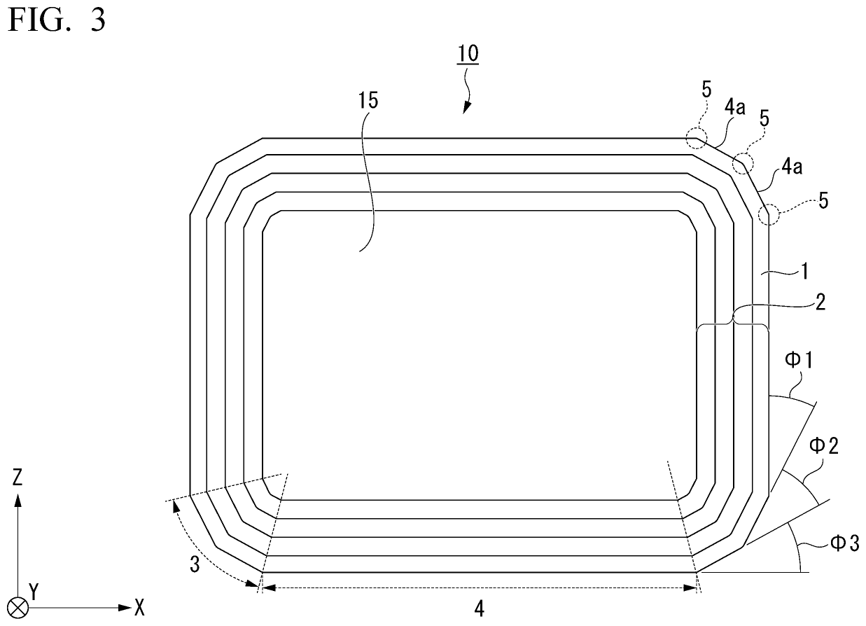

FIG. 1 is a perspective view schematically showing a wound core according to one embodiment. FIG. 2 is a side view of the wound core shown in the embodiment of FIG. 1. In addition, FIG. 3 is a side view schematically showing another embodiment of the wound core.

Here, in the present invention, the side view is a view of the long-shaped grain-oriented electrical steel sheet constituting the wound core in the width direction (Y-axis direction in FIG. 1). The side view is a view showing a shape visible from the side (a view in the Y-axis direction in FIG. 1).

A wound core according to one embodiment of the present invention includes a substantially polygonal wound core main body in a side view. The wound core main body 10 has a substantially rectangular laminated structure in a side view in which grain-oriented electrical steel sheets 1 are stacked in a sheet thickness direction. The wound core main body 10 may be used as a wound core without change, or may include, as necessary, for example, a known fastener such as a binding band for integrally fixing a plurality of stacked grain-oriented electrical steel sheets. Here, the surface roughness to be described below is a value measured for the wound core main body excluding the binding band and the like.

In the present embodiment, the iron core length of the wound core main body 10 is not particularly limited. If the number of bent portions 5 is the same, even if the iron core length of the wound core main body 10 changes, the volume of the bent portion 5 is constant so that the iron loss generated in the bent portion 5 is constant. If the iron core length is longer, the volume ratio of the bent portion 5 to the wound core main body 10 is smaller and the influence on iron loss deterioration is also small. Therefore, a longer iron core length of the wound core main body 10 is preferable. The iron core length of the wound core main body 10 is preferably 1.5 m or more and more preferably 1.7 m or more. Here, in the present invention, the iron core length of the wound core main body 10 is the circumferential length at the central point in the laminating direction of the wound core main body 10 in a side view.

Such a wound core can be suitably used for any conventionally known application.

The iron core according to the present embodiment has substantially a polygonal shape in a side view. In the description using the following drawings, for simplicity of illustration and description, a substantially rectangular (square) iron core, which is a general shape, will be described, but iron cores having various shapes can be produced depending on the angle and number of bent portions 5 and the length of the planar portion. For example, if the angles of all the bent portions 5 are 45° and the lengths of the planar portions 4 are equal, the side view is octagonal. In addition, if the angle is 60°, there are six bent portions 5, and the lengths of the planar portions 4 are equal, the side view is hexagonal.

As shown in FIG. 1 and FIG. 2, the wound core main body 10 includes a portion in which the grain-oriented electrical steel sheets 1 in which the planar portions 4 and 4a and the bent portions 5 are alternately continuous in the longitudinal direction are stacked in a sheet thickness direction and has a substantially rectangular laminated structure 2 having a hollow portion 15 in a side view. A corner portion 3 including the bent portion 5 has two or more bent portions 5 having a curved shape in a side view, and the sum of the bent angles of the bent portions 5 present in one corner portion 3 is, for example, 90°. The corner portion 3 has a planar portion 4a shorter than the planar portion 4 between the adjacent bent portions 5 and 5. Therefore, the corner portion 3 has a form including two or more bent portions 5 and one or more planar portions 4a. Here, in the embodiment of FIG. 2, one bent portion 5 has an angle of 45°. In the embodiment of FIG. 3, one bent portion 5 has an angle of 30°.

As shown in these examples, the wound core of the present embodiment can be formed with the bent portions 5 having various angles, but in order to minimize the occurrence of distortion due to deformation during processing and minimize the iron loss, the bent angle φ (φ1, φ2, φ3) of the bent portion 5 is preferably 60° or less and more preferably 45° or less. The bent angle φ of the bent portion of one iron core can be arbitrarily formed. For example, φ1=60° and φ2=30° can be set. It is preferable that folding angles (bent angles) be equal in consideration of production efficiency, and when the iron loss of the iron core generated according to the iron loss of the steel sheet used can be reduced if deformed portions equal to or larger than a certain size can be reduced, processing may be performed with a combination of different angles. The design can be arbitrarily selected from points that are emphasized in iron core processing.

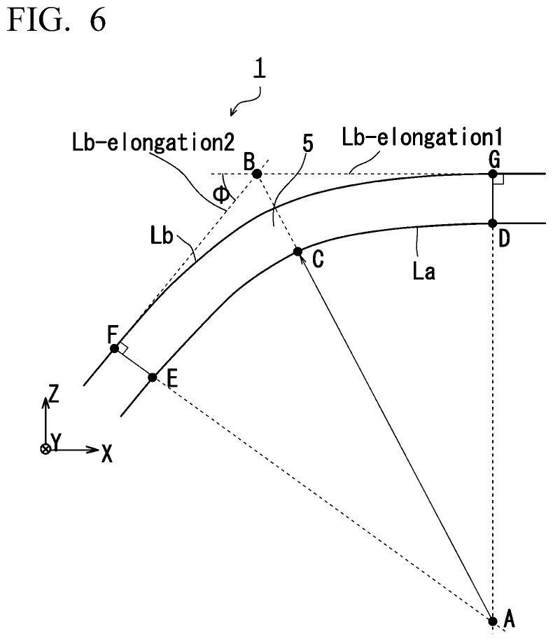

The bent portion 5 will be described in mom detail with reference to FIG. 6. FIG. 6 is a diagram schematically showing an example of the bent portion (curved portion) 5 of the grain-oriented electrical steel sheet 1. The bent angle of the bent portion 5 is the angle difference occurring between the rear straight portion and the front straight portion in the bending direction at the bent portion of the grain-oriented electrical steel sheet, and is expressed, on the outer surface of the grain-oriented electrical steel sheet 1, as an angle φ that is a supplementary angle of the angle formed by two virtual lines Lb-elongation1 and Lb-elongation2 obtained by extending the straight portions that are surfaces of the planar portions 4 and 4a on both sides across the bent portion 5. In this case, the point at which the extended straight line separates from the surface of the steel sheet is the boundary between the planar portion 4 and the bent portion 5 on the outer surface of the steel sheet, which is the point F and the point G in FIG. 6.

In addition, straight lines perpendicular to the outer surface of the steel sheet extend from the point F and the point G and intersections with the inner surface of the steel sheet are the point E and the point D. The point E and the point D are the boundaries between the planar portion 4 and the bent portion 5 on the inner surface of the steel sheet. Here, when the point A and the point B are connected by a straight line, the intersection on a circular arc DE inside the bent portion of the steel sheet is C.

Here, in the present invention, the bent portion 5 is a portion of the grain-oriented electrical steel sheet 1 surrounded by the point D, the point E, the point F, and the point G in a side view of the grain-oriented electrical steel sheet 1. In FIG. 6, the surface of the steel sheet between the point D and the point E, that is, the inner surface of the bent portion 5, is indicated by La, and the surface of the steel sheet between the point F and the point G, that is, the outer surface of the bent portion 5, is indicated by Lb. In addition, in the wound core according to the present disclosure, the radius of curvature in the bent portion 5 of the grain-oriented electrical steel sheet 1 laminated in the laminating direction is not particularly limited.

Here, the method of measuring the radius of curvature r of the bent portion 5 is not particularly limited, and for example, the radius of curvature r can be measured by performing observation using a commercially available microscope (Nikon ECLIPSE LV150) at a magnification of 200. Specifically, the curvature center point A is obtained from the observation result, and for a method of obtaining this, for example, if the intersection of the line segment EF and the line segment DG extended inward on the side opposite to the point B is defined as A, the magnitude of the radius of curvature r corresponds to the length of the line segment AC.

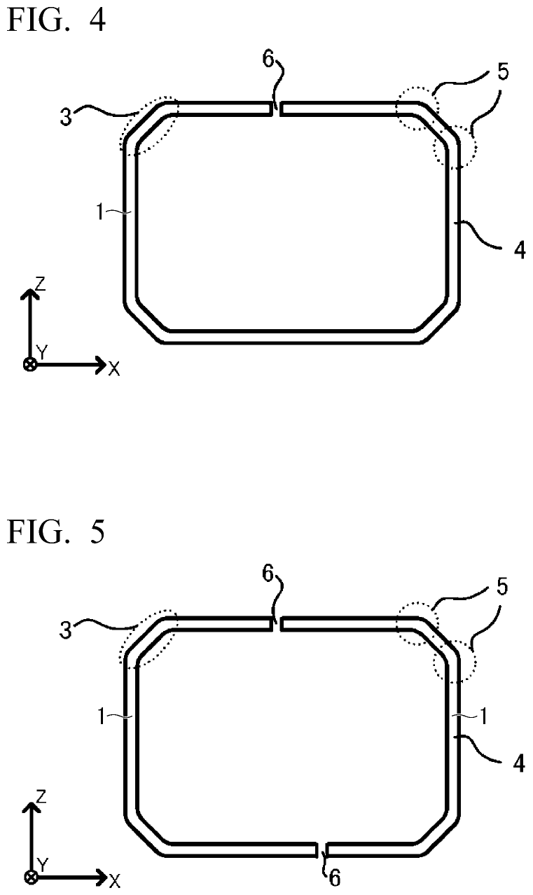

FIG. 4 and FIG. 5 are diagrams schematically showing an example of a single-layer grain-oriented electrical steel sheet 1 in the wound core main body 10. The grain-oriented electrical steel sheet 1 used in the examples of FIG. 4 and FIG. 5 is bent to realize a Unicore type wound core, and includes two or more bent portions 5 and the planar portion 4, and forms a substantially polygonal ring in a side view via a joining part 6 (gap) that is an end surface of one or more grain-oriented electrical steel sheets 1 in the longitudinal direction.

In the present embodiment, the entire wound core main body 10 may have a substantially polygonal laminated structure in a side view. As shown in the example of FIG. 4, one grain-oriented electrical steel sheet may form one layer of the wound core main body 10 via one joining part 6 (one grain-oriented electrical steel sheet is connected via one joining part 6 for each roll), and as shown in the example of FIG. 5, one grain-oriented electrical steel sheet 1 may form about half the circumference of the wound core, and two grain-oriented electrical steel sheets 1 may form one layer of the wound core main body 10 via two joining parts 6 (two grain-oriented electrical steel sheets are connected to each other via two joining parts 6 for each roll).

The sheet thickness of the grain-oriented electrical steel sheet 1 used in the present embodiment is not particularly limited, and may be appropriately selected according to applications and the like, but is generally within a range of 0.15 mm to 0.35 mm and preferably in a range of 0.18 mm to 0.27 mm.

In addition, the method of producing the grain-oriented electrical steel sheet 1 is not particularly limited, and a conventionally known method of producing a grain-oriented electrical steel sheet can be appropriately selected. Specific examples of a preferable production method include, for example, a method in which a slab containing 0.04 to 0.1 mass % of C, with the remainder being the chemical composition of the grain-oriented electrical steel sheet, is heated to 1,000° C. or higher and hot-rolled sheet annealing is then performed as necessary, and a cold-rolled steel sheet is then obtained by cold-rolling once, twice or more with intermediate annealing, the cold-rolled steel sheet is heated, decarburized and annealed, for example, at 700 to 900° C. in a wet hydrogen-inert gas atmosphere, and as necessary, nitridation annealing is additionally performed, an annealing separator is applied, finish annealing is then performed at about 1,000° C., and an insulation coating is formed at about 900° C. In addition, after that, a coating or the like for adjusting the dynamic friction coefficient may be implemented.

In addition, generally, the effects of the present invention can be obtained even with a steel sheet that has been subjected to a treatment called “magnetic domain control” using strain, grooves or the like in the steel sheet producing process by a known method.

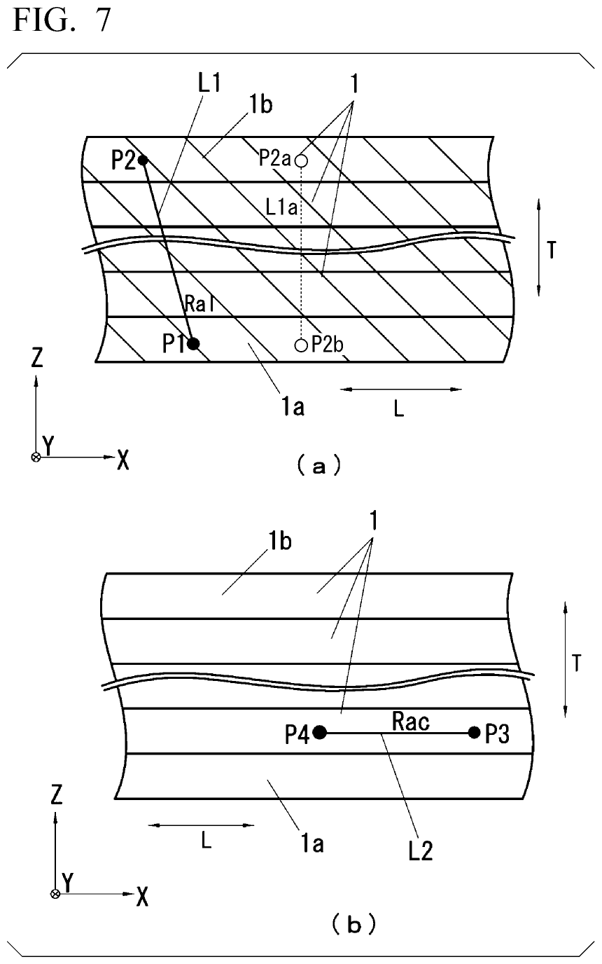

In addition, in the present embodiment, a wound core 10 composed of the grain-oriented electrical steel sheet 1 having the above form is formed by stacking the grain-oriented electrical steel sheets 1 that have been individually bent in layers and assembled into a wound shape, and a plurality of grain-oriented electrical steel sheets 1 are connected to each other via at least one joining part 6 for each roll, and in an L cross section (refer to FIG. 7(a)) parallel to a longitudinal direction L (X direction), which is a cross section of the grain-oriented electrical steel sheet 1 in a sheet thickness direction T, the surface roughness of a steel sheet portion along a straight line L1 connecting an arbitrary point P1 on a grain-oriented electrical steel sheet 1a positioned on the innermost periphery of the wound shape among the laminated grain-oriented electrical steel sheets 1 and an arbitrary point P2 on a grain-oriented electrical steel sheet 1b positioned on the outermost periphery is Ral, and the surface roughness of a steel sheet portion along a straight line L2 connecting arbitrary points P3 and P4 on an end surface (refer to a side end view in FIG. 7(b)) in the sheet thickness direction T parallel to the longitudinal direction in any one of the laminated grain-oriented electrical steel sheets 1 is Rac, the ratio Ral/Rac satisfies the relationship of 1.5≤Ral/Rac≤12.0. Here, “L cross section parallel to the longitudinal direction L (X direction) which is a cross section in the sheet thickness direction T” is not a surface after the wound core 10 is cut out, but an end surface of the wound core 10 parallel to the longitudinal direction of the grain-oriented electrical steel sheet 1 in the sheet thickness direction T of the grain-oriented electrical steel sheet 1 of the wound core 10. The surface roughness Ral is preferably, in the sheet thickness direction T of the grain-oriented electrical steel sheet 1, the surface roughness of the steel sheet portion in a direction L1a connecting the center P1a on the grain-oriented electrical steel sheet 1a positioned on the innermost periphery in the sheet thickness direction and the center P2a on the grain-oriented electrical steel sheet 1b positioned on the outermost periphery in the sheet thickness direction T. The surface roughness Ral may be, for example, an average value of values obtained by performing measurement at five locations obtained by equally dividing the planar portion 4 of the grain-oriented electrical steel sheet 1a in the longitudinal direction. In addition, regarding the surface roughness Rac, since the surface roughness of the grain-oriented electrical steel sheet in the longitudinal direction has a small variation, it may be measured by selecting any one grain-oriented electrical steel sheet, and for example, three grain-oriented electrical steel sheets may be selected and measured, and the average of these measurement values may be used. The surface roughness Rac may be a surface roughness in a direction parallel to the longitudinal direction on the end surface (end surface of the planar portion 4 parallel to the longitudinal direction) of the planar portion 4 of the grain-oriented electrical steel sheet 1.

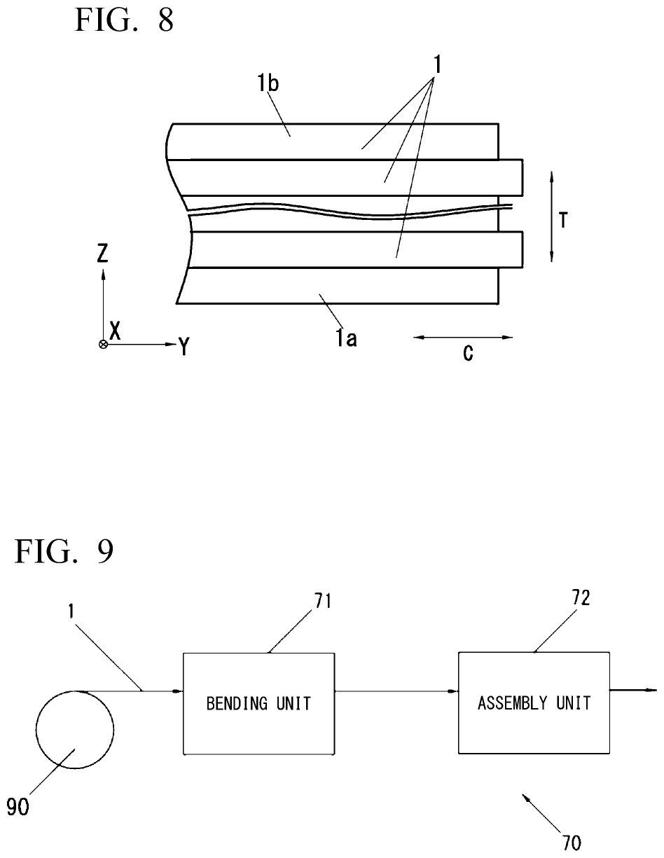

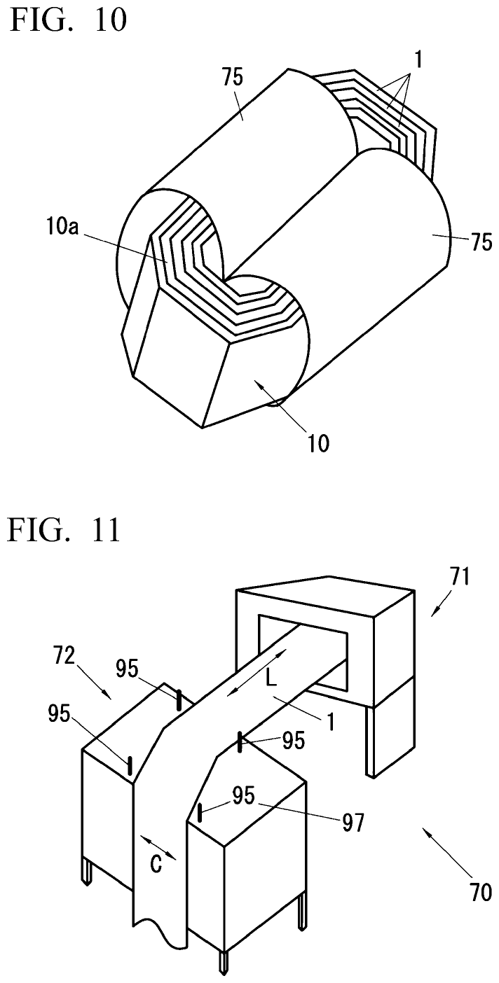

In the present embodiment, in order for the surface roughness ratio to satisfy such a relationship, the grain-oriented electrical steel sheets 1 are stacked such that each of the grain-oriented electrical steel sheets forms one corresponding layer (one layer of the wound core), and any one or more of the grain-oriented electrical steel sheets 1 to be stacked are assembled over the entire length in the longitudinal direction L so that they are shifted with respect to the grain-oriented electrical steel sheets 1 forming other layers in the width direction C perpendicular to the longitudinal direction L. Particularly, in the present embodiment, as shown in FIG. 8 (C end surface parallel to the width direction; an end view of a cut portion along the line A-A in FIG. 1), the grain-oriented electrical steel sheets 1 are assembled so that they are alternately shifted in the width direction C (Y direction) between adjacent layers. Here, the straight line L1 for defining the surface roughness Ral may extend parallel to the laminating direction of the grain-oriented electrical steel sheet 1, but may be inclined in the vertical direction as shown in FIG. 7(a). The straight line L1 for defining the surface roughness Ral preferably extends parallel to the laminating direction of the grain-oriented electrical steel sheet 1. The straight line L2 for defining the surface roughness Rac may vertically extend in the laminating direction of the grain-oriented electrical steel sheet 1, but may be inclined in the vertical direction as shown in FIG. 7(b). The straight line L2 for defining the surface roughness Rac preferably vertically extends in the laminating direction of the grain-oriented electrical steel sheet 1. In addition, for example, the surface roughnesses Ral and Rac can be calculated based on the arithmetic average roughness Ra defined in Japanese Industrial Standard JIS B 0601 (2013), and particularly, in the present embodiment, in the state shown in FIG. 10 in which a winding wire 75 is wound around an iron core 10, on the upper surface (the end surface and the L cross section) 10a of the iron core 10, for example, using a digital microscope (VHX-7000, commercially available from Keyence Corporation), the surface roughnesses Ral and Rac are measured. Specifically, the magnification is set so that the entire L end surface of the outermost peripheral grain-oriented electrical steel sheet 1b and L end surface of the innermost peripheral grain-oriented electrical steel sheet 1a is within a field of view, and measurement is performed using a digital microscope by scanning along straight lines L1 and L2 (refer to FIG. 7). In this case, the cut off of the roughness curve can be appropriately set. When the arithmetic average roughness Ra is measured using a digital microscope, the cutoff value λs=0 μm and the cutoff value λc=0 mm, and vibration correction may be performed for measurement. The measurement magnification is preferably 100 or more and more preferably 500 to 700. When the arithmetic average roughness Ra is used, the surface roughness Ral may be, for example, 0.6 to 14.4 μm, and the surface roughness Rac may be, for example, 0.5 to 1.2 μm.

In addition, FIG. 9 schematically shows a block diagram of a device that can produce the wound core as described above. FIG. 9 schematically shows a production device 70 for a Unicore type wound core. The production device 70 includes a bending unit 71 that individually bends the grain-oriented electrical steel sheets 1 and an assembly unit 72 that stacks the grain-oriented electrical steel sheets 1 that have been individually bent in layers by the bending unit 71 and assembled into a wound shape to form a wound core having a wound shape including a rectangular hollow portion in the center in which the plurality of grain-oriented electrical steel sheets are connected to each other via at least one joining part for each roll and which includes a portion in which the grain-oriented electrical steel sheets 1 in which the planar portions 4 and the bent portions 5 are alternately continuous in the longitudinal direction are stacked in a sheet thickness direction.

The grain-oriented electrical steel sheets 1 are a fed at a predetermined conveying speed from a steel sheet supply unit 90 that holds a hoop member formed by winding the grain-oriented electrical steel sheet 1 in a roll shape and supplied to the bending unit 71. The grain-oriented electrical steel sheets 1 supplied in this manner are appropriately cut to an appropriate size in the bending unit 71 and subjected to bending in which a small number of sheets are individually bent such as one sheet at a time.

Here, as described above, in order for the surface roughness ratio Ral/Rac to satisfy the relationship of 1.5≤Ral/Rac≤12.0, the assembly unit 72 stacks the grain-oriented electrical steel sheets 1 such that each of the grain-oriented electrical steel sheets forms one corresponding layer (one layer of the wound core), and changes the position of a guide 95 in the width direction, and thus assembles any one or more of the grain-oriented electrical steel sheets 1 to be stacked over the entire length in the longitudinal direction L so that they are shifted in the width direction C perpendicular to the longitudinal direction L with respect to the grain-oriented electrical steel sheets 1 forming other layers. Particularly, in the present embodiment, as shown in FIG. 11, the assembly unit 72 includes a plurality of guides 95 that regulate positions of both ends of the grain-oriented electrical steel sheet 1 in the width direction C and guide the grain-oriented electrical steel sheet 1 in the longitudinal direction L on a steel sheet reception portion 97, and shifts the grain-oriented electrical steel sheet 1 supplied from the bending unit 71 in the width direction C by changing the position of the guide 95 in the width direction C. Therefore, any one or more of the grain-oriented electrical steel sheets 1 to be stacked can be assembled over the entire length in the longitudinal direction so that they are shifted with respect to the grain-oriented electrical steel sheets 1 forming other layers in the width direction C perpendicular to the longitudinal direction. Here, particularly, whenever one grain-oriented electrical steel sheet 1 is stacked, the guide 95 protrudes from another position shifted in the width direction C and shifts a subsequent portion of the grain-oriented electrical steel sheet 1 in the width direction C.

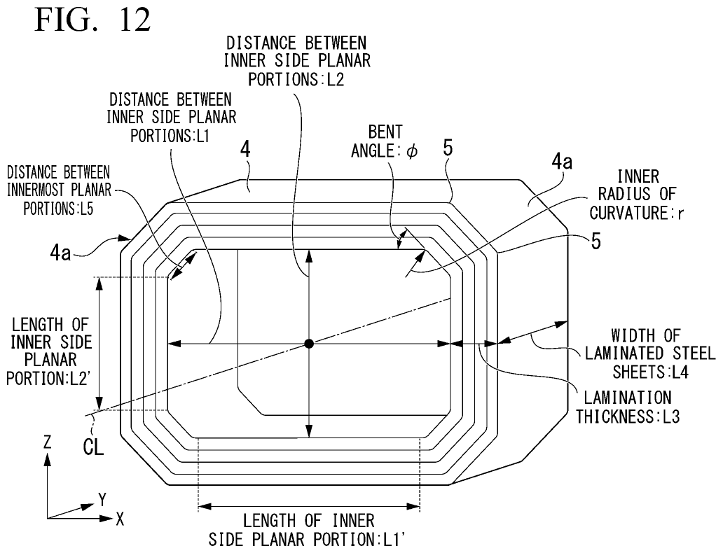

Next, data verifying that the temperature rise of the wound core 10 having the above configuration according to the present embodiment and the winding wire wound therearound is minimized is shown below. The inventors produced iron cores a to d having shapes shown in Table 1 and FIG. 12 using respective steel sheets as materials when acquiring the verification data.

Here, L1 is parallel to the X-axis direction and is a distance between parallel grain-oriented electrical steel sheets 1 on the innermost periphery of the wound core in a flat cross section including the center CL (a distance between inner side planar portions). L2 is parallel to the Z-axis direction and is a distance between parallel grain-oriented electrical steel sheets 1 on the innermost periphery of the wound core in a vertical cross section including the center CL (a distance between inner side planar portions). L3 is parallel to the X-axis direction and is a lamination thickness of the wound core in a flat cross section including the center CL (a thickness in the laminating direction). L4 is parallel to the X-axis direction and is a width of the laminated steel sheets of the wound core in a flat cross section including the center CL. L5 is a distance between planar portions that are adjacent to each other in the innermost portion of the wound core and arranged to form a right angle together (a distance between bent portions). In other words, L5 is a length of the planar portion 4a in the longitudinal direction which has the shortest length among the planar portions 4 and 4a of the grain-oriented electrical steel sheets on the innermost periphery. r is the radius of curvature of the bent portion 5 on the inner side of the wound core. φ is the bent angle of the bent portion 5 of the wound core. The cores Nos. a to d of the substantially rectangular iron cores in Table 1 have a structure in which a planar portion with an inner side planar portion distance of L1 is divided at approximately in the center of the distance L1 and two iron cores having “substantially a U-shape” are connected.

Here, the iron core of the core No. c is conventionally used as a general wound core, and is a so-called trunk core type wound core having a radius of curvature of 25 mm produced by a method of shearing a steel sheet, winding it into a cylindrical shape, then pressing the cylindrical laminated body without change so that the corner portion has a constant curvature, and forming it into substantially a rectangular shape. In addition, the iron core of the core No. d is a Unicore type wound core having a radius of curvature r of 1 mm including three bent portions 5 at one corner portion 3, the iron core of the core No. a is a Unicore type wound core having a radius of curvature r of 1 mm including two bent portions 5 at one corner portion 3, and the iron core of the core No. b is a Unicore type wound core having a radius of curvature r that is considerably larger than the iron cores of the cores Nos. a and d (a radius of curvature r of 20 mm).

TABLE 1

| | Core shape | | | | | | |
|---|---|---|---|---|---|---|---|
| Core | L1 | L2 | L3 | L4 | L5 | r | ϕ |
| No. | mm | mm | mm | mm | mm | mm | ° |
| a | 197 | 66 | 47 | 152.4 | 4 | 1 | 45 |
| b | 197 | 66 | 47 | 152.4 | 4 | 20 | 45 |
| c | 197 | 66 | 47 | 152.4 | 4 | 25 | 90 |
| d | 197 | 66 | 47 | 152.4 | 4 | 1 | 30 |

Table 2A and Table 2B show, based on various core shapes as described above, the above surface roughness ratio Ral/Rac obtained by measuring set 58 example materials in which the steel sheet thickness (mm) was set and the measured and evaluated temperature rise ΔT(° C.) of the iron core and the winding wire. Here, the surface roughnesses Ral and Rac used for calculating Ral/Rac both are the arithmetic average roughness Ra measured using a digital microscope (VHX-7000, commercially available from Keyence Corporation). The arithmetic average roughness Ra was measured based on JIS B 0601 (2013). The cutoff values were λs=0 and λc=0, and vibration correction was performed for measurement. The measurement magnification was set to 500 to 700.

In evaluation of the temperature rise, a sample shown in FIG. 10 was prepared by winding the winding wire 75 around the iron core 10, immersed in an oil, operated at a load rate of 40% and a set magnetic flux density of 1.7 T for 72 hours, the temperature of the oil was then measured, and the temperature rise (temperature after 2 hours-initial temperature) was evaluated. 6.6 degree or less was determined to be satisfactory.

TABLE 2A

| | | Steel sheet | Ratio: | Temperature rise |
|---|---|---|---|---|
| No. | Core No. | thickness (mm) | Ral/Rac | ΔT (° C.) |
| 1 | a | 0.23 | 1.0 | 8.4 |
| 2 | a | 0.23 | 1.0 | 8.7 |
| 3 | a | 0.23 | 1.0 | 8.6 |
| 4 | a | 0.23 | 1.5 | 6.6 |
| 5 | a | 0.23 | 2.0 | 3.8 |
| 6 | a | 0.23 | 2.3 | 2.8 |
| 7 | a | 0.23 | 4.0 | 1.6 |
| 8 | a | 0.23 | 5.5 | 1.4 |
| 9 | a | 0.23 | 7.0 | 1.7 |
| 10 | a | 0.23 | 8.1 | 3.2 |
| 11 | a | 0.23 | 8.6 | 3.7 |
| 12 | a | 0.23 | 12.0 | 6.4 |
| 13 | a | 0.23 | 14.9 | 7.8 |
| 14 | a | 0.23 | 19.9 | 8.8 |
| 15 | a | 0.23 | 27.2 | 9.0 |
| 16 | a | 0.23 | 39.4 | 12 |
| 17 | a | 0.23 | 49.0 | 11 |
| 18 | a | 0.23 | 60.6 | 16 |
| 19 | a | 0.15 | 1.0 | 9.4 |
| 20 | a | 0.15 | 2.3 | 3.7 |
| 21 | a | 0.15 | 4.0 | 2.0 |
| 22 | a | 0.15 | 7.0 | 1.7 |
| 23 | a | 0.15 | 14.9 | 9.6 |
| 24 | a | 0.18 | 1.0 | 8.4 |
| 25 | a | 0.18 | 2.3 | 2.2 |
| 26 | a | 0.18 | 4.0 | 1.3 |
| 27 | a | 0.18 | 7.0 | 1.4 |
| 28 | a | 0.18 | 14.9 | 7.3 |
| 29 | a | 0.27 | 1.0 | 8.4 |

TABLE 2B

| | | Steel sheet | Ratio: | Temperature rise |
|---|---|---|---|---|
| No. | Core No. | thickness (mm) | Ral/Rac | ΔT (° C.) |
| 30 | a | 0.27 | 2.3 | 2.2 |
| 31 | a | 0.27 | 4.0 | 1.3 |
| 32 | a | 0.27 | 6.9 | 1.4 |
| 33 | a | 0.27 | 14.9 | 7.3 |
| 34 | a | 0.30 | 1.0 | 9.4 |
| 35 | a | 0.30 | 2.3 | 3.7 |
| 36 | a | 0.30 | 4.0 | 2.0 |
| 37 | a | 0.30 | 7.0 | 1.7 |
| 38 | a | 0.30 | 14.5 | 9.6 |
| 39 | a | 0.35 | 1.0 | 9.4 |
| 40 | a | 0.35 | 2.3 | 3.7 |
| 41 | a | 0.35 | 4.0 | 2.0 |
| 42 | a | 0.35 | 7.0 | 1.7 |
| 43 | a | 0.35 | 14.9 | 9.6 |
| 44 | b | 0.23 | 1.0 | 8.4 |
| 45 | b | 0.23 | 2.3 | 2.2 |
| 46 | b | 0.23 | 4.0 | 1.3 |
| 47 | b | 0.23 | 6.8 | 1.4 |
| 48 | b | 0.23 | 14.9 | 7.3 |
| 49 | c | 0.23 | 1.0 | 8.4 |
| 50 | c | 0.23 | 2.3 | 2.2 |
| 51 | c | 0.23 | 4.0 | 1.3 |
| 52 | c | 0.23 | 7.0 | 1.4 |
| 53 | c | 0.23 | 14.9 | 7.3 |
| 54 | d | 0.23 | 1.0 | 8.4 |
| 55 | d | 0.23 | 2.3 | 2.2 |
| 56 | d | 0.23 | 3.9 | 1.3 |
| 57 | d | 0.23 | 7.0 | 1.4 |
| 58 | d | 0.23 | 14.9 | 7.3 |

As can be understood from Table 2A and Table 2B, regarding all iron cores of the cores Nos. a, b, c, and d, regardless of the sheet thickness, if the surface roughness ratio Ral/Rac was within a range of 1.5≤Ral/Rac≤12.0, the temperature rise ΔT(° C.) of the iron core and the winding wire was reduced to 6.6° C. or less with some exceptions.

Based on the above results, it can be clearly understood that, in the wound core of the present invention, when the grain-oriented electrical steel sheets 1 were assembled so that they were shifted in the width direction, the surface area of the L cross section increased, and the surface roughness Ral of the L cross section of the wound core was changed, thereby the surface roughness ratio Ral/Rac satisfied the relationship of 1.5≤Ral/Rac≤12.0. Thus, it was possible to effectively reduce the temperature rise of the iron core and the winding wire.

### APPENDIX

A wound core, a method of producing a wound core, and a wound core production device according to the above embodiments can be understood as follows.
(1) A wound core of the present disclosure is a wound core having a wound shape including a rectangular hollow portion in the center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll,
   in which, in an L cross section parallel to the longitudinal direction which is a cross section of the grain-oriented electrical steel sheet in a sheet thickness direction,
   when the surface roughness of a steel sheet portion along a straight line connecting an arbitrary point on a grain-oriented electrical steel sheet positioned on the innermost periphery of the wound shape among the laminated grain-oriented electrical steel sheets and an arbitrary point on a grain-oriented electrical steel sheet positioned on the outermost periphery is Ral, and the surface roughness of a steel sheet portion along a straight line connecting arbitrary points on an end surface in a sheet thickness direction parallel to the longitudinal direction in any one of the laminated grain-oriented electrical steel sheets is Rac, the ratio Ral/Rac satisfies the relationship of 1.5≤Ral/Rac≤12.0.
(2) A method of producing a wound core of the present disclosure that is a wound core having a wound shape including a rectangular hollow portion in the center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll,
   the method including
   assembling any one or more of the grain-oriented electrical steel sheets that are stacked such that each of the grain-oriented electrical steel sheets forms one corresponding layer over the entire length in the longitudinal direction so that they are shifted with respect to grain-oriented electrical steel sheets forming other layers in a width direction perpendicular to the longitudinal direction,
   and thereby, in an L cross section parallel to the longitudinal direction which is a cross section of the grain-oriented electrical steel sheet in a thickness direction, when the surface roughness of a steel sheet portion along a straight line connecting an arbitrary point on a grain-oriented electrical steel sheet positioned on the innermost periphery of the wound shape among the laminated grain-oriented electrical steel sheets and an arbitrary point on a grain-oriented electrical steel sheet positioned on the outermost periphery is Ral and the surface roughness of a steel sheet portion along a straight line connecting arbitrary points on an end surface in a sheet thickness direction parallel to the longitudinal direction in any one of the laminated grain-oriented electrical steel sheets is Rac, the ratio Ral/Rac satisfies the relationship of 1.5≤Ral/Rac≤12.0.

A wound core production device of the present disclosure includes a bending unit that individually bends grain-oriented electrical steel sheets, and
an assembly unit that stacks the grain-oriented electrical steel sheets that have been individually bent in layers by the bending unit and assembles them into a wound shape to form a wound core having a wound shape including a rectangular hollow portion in the center in which the plurality of grain-oriented electrical steel sheets are connected to each other via at least one joining part for each roll and which includes a portion in which grain-oriented electrical steel sheets in which planar portions and bent portions are alternately continuous in a longitudinal direction are stacked in a sheet thickness direction,
the assembly unit assembles any one or more of the grain-oriented electrical steel sheets that are stacked such that each of the grain-oriented electrical steel sheets forms one corresponding layer over the entire length in the longitudinal direction so that they are shifted with respect to grain-oriented electrical steel sheets forming other layers in a width direction perpendicular to the longitudinal direction,
and thereby, in an L cross section parallel to the longitudinal direction which is a cross section of the grain-oriented electrical steel sheet in a thickness direction, when the surface roughness of a steel sheet portion along a straight line connecting an arbitrary point on a grain-oriented electrical steel sheet positioned on the innermost periphery of the wound shape among the laminated grain-oriented electrical steel sheets and an arbitrary point on a grain-oriented electrical steel sheet positioned on the outermost periphery is Ral and the surface roughness of a steel sheet portion along a straight line connecting arbitrary points on an end surface in a sheet thickness direction parallel to the longitudinal direction in any one of the laminated grain-oriented electrical steel sheets is Rac, the ratio Ral/Rac satisfies the relationship of 1.5≤Ral/Rac≤12.0, and the assembly unit includes a guide that regulates positions of both ends of the grain-oriented electrical steel sheet in the width direction and guides the grain-oriented electrical steel sheet in the longitudinal direction, and the grain-oriented electrical steel sheet is shifted in the width direction by changing the position of the guide.

### BRIEF DESCRIPTION OF THE REFERENCE SYMBOLS

1 Grain-oriented electrical steel sheet
4 Planar portion
5 Bent portion
6 Joining part
10 Wound core (wound core main body)

1. A wound core having a wound shape including a rectangular hollow portion in the center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll,
wherein, in an end surface of the wound core that is in a sheet thickness direction of the grain-oriented electrical steel sheets and parallel to the longitudinal direction of the grain-oriented electrical steel sheets,
in the sheet thickness direction,
when a surface roughness of a steel sheet portion in a direction connecting a center in the sheet thickness direction of a grain-oriented electrical steel sheet positioned on the innermost periphery of the wound core among the laminated grain-oriented electrical steel sheets and a center in the sheet thickness direction of a grain-oriented electrical steel sheet positioned on the outermost periphery of the wound core is Ral, and a surface roughness of the grain-oriented electrical steel sheet in a direction parallel to the longitudinal direction on an end surface of the planar portion of the laminated grain-oriented electrical steel sheet is Rac, a ratio Ral/Rac between Ral and Rac satisfies the relationship of 1.5≤Ral/Rac≤12.0.

2. A method of producing a wound core that is a wound core having a wound shape including a rectangular hollow portion in the center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll, the method comprising:
stacking the grain-oriented electrical steel sheets so that each of the grain-oriented electrical steel sheets forms one layer of the wound core; and
assembling any one or more of the stacked grain-oriented electrical steel sheets over the entire length in the longitudinal direction so that they are shifted with respect to grain-oriented electrical steel sheets forming other layers in a width direction perpendicular to the longitudinal direction,
thereby in an end surface of the wound core that is in a sheet thickness direction of the grain-oriented electrical steel sheets and parallel to the longitudinal direction of the grain-oriented electrical steel sheets, in the sheet thickness direction,
when a surface roughness of a steel sheet portion in a direction connecting a center in the sheet thickness direction of a grain-oriented electrical steel sheet positioned on the innermost periphery of the wound core among the laminated grain-oriented electrical steel sheets and a center in the sheet thickness direction of a grain-oriented electrical steel sheet positioned on the outermost periphery of the wound core is Ral, and
a surface roughness of the grain-oriented electrical steel sheet in a direction parallel to the longitudinal direction on an end surface of the planar portion of the laminated grain-oriented electrical steel sheet is Rac, a ratio Ral/Rac between Ral and Rac satisfies the relationship of 1.5≤Ral/Rac≤12.0.

3. A wound core production device, comprising:
a bending unit that individually bends grain-oriented electrical steel sheets; and
an assembly unit that stacks the grain-oriented electrical steel sheets that have been individually bent in layers by the bending unit and assembles them into a wound shape to form a wound core having a wound shape including a rectangular hollow portion in the center in which the plurality of grain-oriented electrical steel sheets are connected to each other via at least one joining part for each roll and which includes a portion in which the grain-oriented electrical steel sheets in which planar portions and bent portions are alternately continuous in a longitudinal direction are stacked in a sheet thickness direction,
wherein the assembly unit includes a guide that regulates positions of both ends of the grain-oriented electrical steel sheet in a width direction and guides the grain-oriented electrical steel sheet in the longitudinal direction,
wherein, the assembly unit stacks the grain-oriented electrical steel sheets so that each of the grain-oriented electrical steel sheets forms one layer of the wound core, and
assembles any one or more of the stacked grain-oriented electrical steel sheets over the entire length in the longitudinal direction so that they are shifted with respect to the grain-oriented electrical steel sheets forming other layers in a width direction perpendicular to the longitudinal direction by changing the position of the guide in the width direction so that
in an end surface of the wound core that is in a sheet thickness direction of the grain-oriented electrical steel sheets and parallel to the longitudinal direction of the grain-oriented electrical steel sheets,
in the sheet thickness direction,
when a surface roughness of a steel sheet portion in a direction connecting a center in the sheet thickness direction of a grain-oriented electrical steel sheet positioned on the innermost periphery of the wound core among the laminated grain-oriented electrical steel sheets and a center in the sheet thickness direction of a grain-oriented electrical steel sheet positioned on the outermost periphery of the wound core is Ral, and
a surface roughness of the grain-oriented electrical steel sheet in a direction parallel to the longitudinal direction on an end surface of the planar portion of the laminated grain-oriented electrical steel sheet is Rac, a ratio Ral/Rac between Ral and Rac satisfies the relationship of 1.5≤Ral/Rac≤12.0.
